(19) United States
(12) Patent Application Publication
(10) Pub. No.: US 2017/0102139 A1
(43) Pub. Date: Apr. 13, 2017

(54) LIGHTING DEVICE AND LIGHTING APPARATUS

(71) Applicant: PANASONIC INTELLECTUAL PROPERTY MANAGEMENT CO., LTD., Osaka (JP)

(72) Inventors: Noboru IIZAWA, Osaka (JP); Masahito YAMANA, Hyogo (JP); Yoshiyuki NAKANO, Osaka (JP)

(73) Assignee: PANASONIC INTELLECTUAL PROPERTY MANAGEMENT CO., LTD., Osaka (JP)

(21) Appl. No.: 15/285,912

(22) Filed: Oct. 5, 2016

(30) Foreign Application Priority Data
Oct. 9, 2015 (JP) 2015-201570

(51) Int. Cl. F21V 29/70; F21V 5/04; F21V 9/16; F21V 9/08; F21V 29/83; F21V 8/00

(52) U.S. Cl. CPC F21V 29/70; F21V 29/83; G02B 6/0008; F21V 9/16; F21V 9/08; F21V 5/04; F21Y 2115/10

(57) ABSTRACT

A lighting device includes: a substrate that is light transmissive and has one or more region in which a phosphor layer is formed; a heat transfer plate having a first surface in surface-to-surface contact with a surface of the substrate and having one or more apertures overlapping the one or more regions; and a heat dissipation plate having a surface in surface-to-surface contact with a second surface of the heat transfer plate opposite the first surface and having an aperture overlapping the one or more apertures.

### CROSS REFERENCE TO RELATED APPLICATION

This application claims the benefit of priority of Japanese Patent Application Number 2015-201570 filed on Oct. 9, 2015, the entire content of which is hereby incorporated by reference.

### BACKGROUND

1. Technical Field

The present disclosure relates to a lighting device and a lighting apparatus.

2. Description of the Related Art

A lighting device is known that emits white light by converting portion of blue light from a light source (laser diode (LD)) or a light emitting diode (LED) into yellow light using a phosphor (for example, see Japanese Patent No. 5,556,256).

However, from the viewpoint of supporting installation in various places, aesthetics, and manufacturing costs, there is a need to reduce the size of lighting devices.

### SUMMARY

The amount of heat produced by the phosphor upon converting the color (wavelength) of the light increases with the intensity of the light that excites the phosphor. Typically, the light converting performance of phosphor degrades in high temperature environments. Thus, there is a demand for a lighting device that avoids a degradation in light converting performance by efficiently dissipating heat generated by the phosphor out of the lighting device to inhibit the phosphor from increasing in temperature. The amount of heat dissipated out of the lighting device is typically increased by increasing the surface area of the heat dissipation mechanism in the lighting device, but increasing the surface area of the heat dissipation mechanism is problematic in that doing so increases the overall size of the lighting device, which is contradictory to the above-described need to reduce the size of lighting devices.

In light of this, the present disclosure has an object to provide a lighting device that both avoids an increase in overall size and efficiently dissipates heat.

In order to achieve the above object, a lighting device according to one aspect of the present disclosure includes: a substrate that is light transmissive and has one or more regions in which a phosphor layer is formed; a heat transfer plate having a first surface in surface-to-surface contact with a surface of the substrate and flaying one or more first apertures overlapping the one or more regions; and a heat dissipation plate having a surface in surface-to-surface contact with a second surface of the heat transfer plate opposite the first surface and having a second aperture overlapping the one or more first apertures.

With the lighting device according to the present disclosure, it is possible to avoid an increase in overall size and efficiently dissipate heat.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is an external view of a lighting apparatus according to an embodiment;

FIG. 2 is a cross sectional view of the internal structure of a lighting device included in the lighting apparatus according to the embodiment;

FIG. 3 is an exploded, perspective view of a holder and a phosphor component included in the Lighting device according to the embodiment;

FIG. 4 is a cross sectional view of the holder and the phosphor component included in the lighting device according to the embodiment;

FIG. 5 is a perspective view of a substrate according to the embodiment;

FIG. 6 is a perspective view of a heat transfer plate according to the embodiment;

FIG. 7 is a cross sectional view of the lighting device according to the embodiment;

FIG. 8 illustrates a temperature distribution of a cross section of the lighting device according to related technology 1;

FIG. 9 illustrates a temperature distribution of a cross section of the lighting device according to related technology 2;

FIG. 10 illustrates a temperature distribution of a cross section of the lighting device according to related technology 3;

FIG. 11 illustrates a temperature distribution of a cross section of the lighting device according to the embodiment;

FIG. 12 is a perspective view illustrating the detailed structure of a lens of the lighting device according to the embodiment;

FIG. 13 is a top view of a diffractive lens array according to the embodiment;

FIG. 14 is a cross sectional view taken along line XIV-XIV in FIG. 13;

FIG. 15 is a perspective view illustrating paths of light passing through the diffractive lens array according to the embodiment;

FIG. 16 is a perspective view of a substrate according to Variation 1 of the embodiment;

FIG. 17 is a perspective view of a heat transfer plate according to Variation 1 of the embodiment

FIG. 18 is a perspective view of a substrate according to Variation 2 of the embodiment; and

FIG. 19 is a perspective view of a heat transfer plate according to Variation 2 of the embodiment.

### DETAILED DESCRIPTION OF THE EMBODIMENT

The following describes a lighting device according to an embodiment of the present disclosure with reference to the drawings. Note that the embodiment described below shows a specific, preferred example of the present disclosure. The numerical values, shapes, materials, elements, the arrangement and connection of the elements, steps, order of the steps, etc.., indicated in the following embodiment are mere examples, and therefore do not intend to limit the inventive concept. Therefore, among the elements in the following embodiment, those not recited in any of the independent claims defining the most generic part of the inventive concept; are described as optional elements. Also note that the drawings are schematic in nature and not necessarily precise illustrations.

### Embodiment

In this embodiment, a lighting device that both avoids an increase in overall size and efficiently dissipates heat will be described. Note that like reference signs indicate like elements. As such, overlapping descriptions may be omitted. Also note that the XYZ coordinate axes illustrated in the drawing's may be referenced in the following description

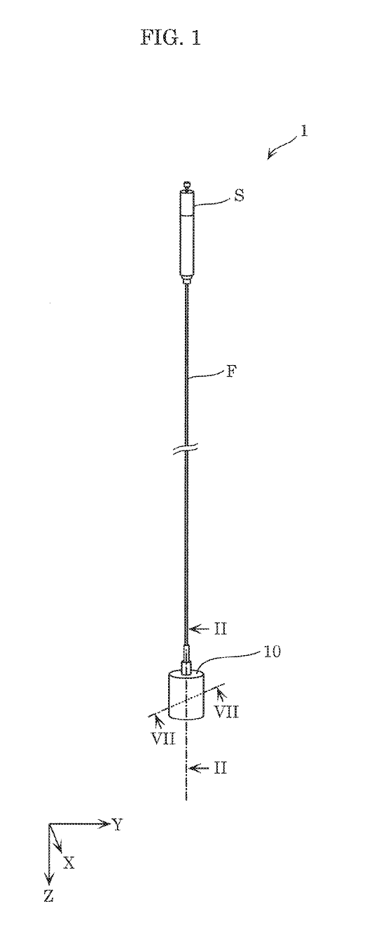

FIG. 1 is an external view of lighting apparatus 1 according to an embodiment.

As illustrated in FIG. 1, lighting apparatus 1 includes light source S, optical fiber F, and lighting device 10.

Light source S is a light source that emits light, and is, for example, a laser diode (LD) or a light emitting diode (LED). More specifically, light source S is an LD or LED that emits blue light, but light source S may emit light of a different color.

Optical fiber F has a two-part structure configured of a core with a high refractive index and cladding with a low refractive index surrounding the core. Optical fiber F functions as a light transmission path for guiding light from light source S to lighting device 10. The core and the cladding are both made of quartz glass or plastic that is highly light transmissive.

Lighting device 10 illuminates its surrounding region by emitting out light transmitted from light source S via optical fiber F. Lighting device 10 has a phosphor layer that converts the color (wavelength) of all or a portion of the light received from optical fiber F. For example, phosphor layer is configured of a yellow phosphor, which converts blue light into yellow light, sealed with, for example, resin. In this case, lighting device 10 produces, and illuminates its surrounding area with, white light as a result of the yellow phosphor converting a portion of the blue light transmitted from light source S into yellow light.

Hereinafter, the configuration of lighting device 10 will be described in detail.

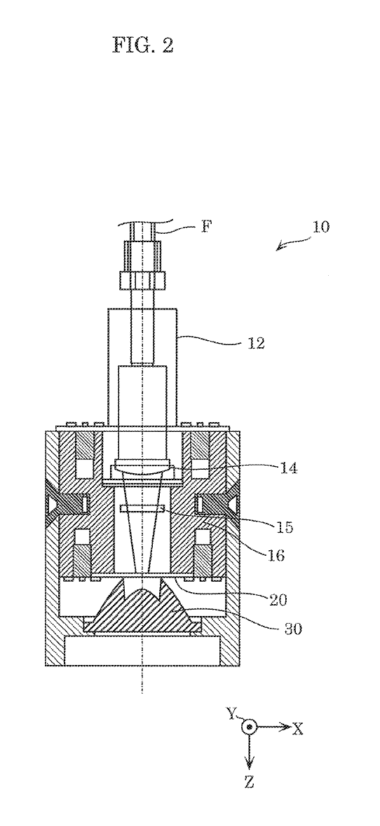

FIG. 2 is a cross sectional view of the internal structure of lighting device 10 included in lighting apparatus 1 according to an embodiment. The cross section of lighting device 10 illustrated in FIG. 2 is taken along line II-II illustrated in FIG. 1.

As illustrated in FIG. 2, lighting device 10 includes fiber coupling 12, lens 14, lens 30, lens array 15, holder 16, and phosphor component 20.

Fiber coupling 12 is an optical component that is connected to optical fiber F and guides, into lighting device 10, light transmitted in the positive direction along the Z axis from light source S via optical fiber F.

Lens 14 is an optical component that changes the path of light incident thereon from fiber coupling 12.

Lens array 15 is an optical component that changes the path of light transmitted through lens 14. More specifically, lens array 15 changes (separates) the path of light by splitting light incident thereon into plurality of paths (for example, three) such that the paths of the split light are incident on phosphor component 20 in mutually different positions. The specific configuration of lens array 15 will he described later with a specific example. Note that lens array 15 may be disposed between fiber coupling 12 and phosphor component 20. In particular, lens array 15 may be disposed so as to be in contact with lens 14, and may be coupled with a portion of lens 14 (that is to say, may be integrally formed with lens 14).

Holder 16 is an enclosure that houses the elements of lighting device 10.

Phosphor component. 20 includes a phosphor that receives light transmitted through lens array 15, converts the color of the received, light, and emits the converted light. In addition to phosphor, phosphor component 20 also includes a heat transfer plate and a heat dissipation plate that function as a heat dissipation mechanism that dissipates heat generated by the phosphor out of lighting device 10. Configurations of these will be described in detail later.

Lens 30 is an optical component that adjusts the distribution properties of light from phosphor component 20 as it exits lighting device 10 (in the positive direction along the Z axis). Depending on its shape, lens 30 either reduces or increases the distribution angle of exiting light. A lens having light distribution properties appropriate for the usage of lighting device 10 may he used as lens 30.

Hereinafter, the configuration of phosphor component 20, etc., of lighting device 10 will be described in detail.

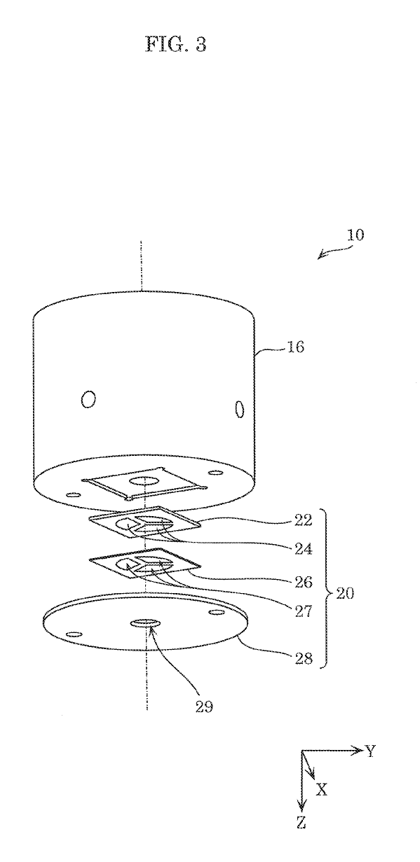

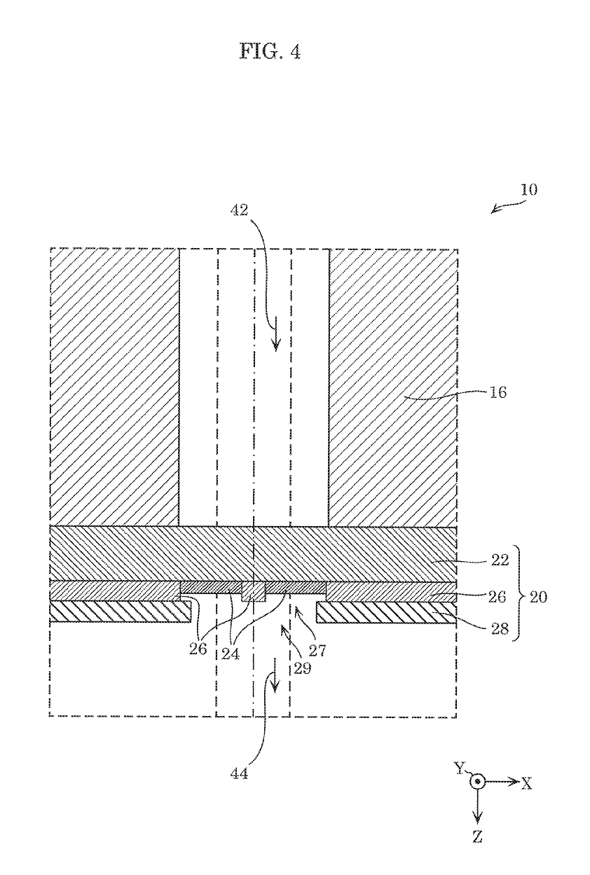

FIG. 3 is an exploded perspective view of holder 16 and phosphor component 20 included in lighting device 10 according to this embodiment. FIG. 4 is a cross sectional view of holder 16 and phosphor component 20 included in lighting device 10 according to this embodiment. The cross section illustrated in FIG. 4 is an enlarged region of holder 16 and phosphor component 20 in the cross section illustrated in FIG. 2.

As illustrated in FIG. 3 and FIG. 4, phosphor component 20 includes substrate 22, phosphor layer 24, heat transfer plate 26, and heat dissipation plate 28.

Substrate 22 is light transmissive. Light from light source S is emitted onto substrate 22 via optical fiber F. Substrate 22 has a region which phosphor layer 24 is provided. Phosphor layer 24 changes the color of light received from light source S via optical fiber F. Phosphor layer 24 is exemplified as being coated onto substrate 22, but the method of forming phosphor layer 24 on substrate 22 is not limited, to this example. Note that the surface having the region in which phosphor layer 24 is coated is also referred to as the first surface, and the surface on the reverse side of substrate 22 is also referred to as the second surface. Moreover, light from optical fiber F is also exemplified as exiting substrate 22 through the second surface. Substrate 22 is, for example, a sapphire substrate.

Substrate 22 may be made of an arbitrary material such as glass or plastic. Here, the glass may be, for example, soda glass or alkali-free glass. Moreover, the plastic may be, for example, acrylic resin, polycarbonate, polyethylene terephthalate (PET), or polyethylene naphthalate (PEN). When substrate 22 is made of a material that is transparent and does not absorb light—that is to say, made of a material having an extinction coefficient of approximately zero—there is an advantage in that the amount of light that transmits through substrate 22 can be increased, resulting in an increase in light illuminating the region surrounding lighting device 10.

Phosphor layer 24 is a wavelength converting material that receives light from light source S via optical fiber and fiber coupling 12, and converts the color (wavelength) of the received light with phosphor particles. Phosphor layer 24 generates heat upon converting the color of the light.

More specifically, phosphor layer 24 includes yellow phosphor particles, such as yttrium aluminum garnet (YAG) phosphor particles, which receive blue light from light source S and emit yellow light, and a resin, such as silicon or epoxy, which seals the phosphor particles. Phosphor layer 24 produces white light as a result of the yellow light converted from a portion of the blue light from light source S by the phosphor particles and the unconverted, remaining blue light mixing together, and emits the produced white light in the positive direction along the Z axis. Typically, the color converting efficiency of phosphor layer 24 decreases (degrades) in high temperature environments. In light of this, lighting device 10 inhibits phosphor layer 24 from reaching high temperatures by sufficiently dissipating heat generated by phosphor layer 24, out of lighting device 10 via heat transfer plate 26 and heat dissipation plate 28 functioning as a heat dissipation mechanism. Note that a material having a high rate of heat conductivity, such as an inorganic oxide like ZnO, may he mixed into the resin included in phosphor layer 24 to increase heat dissipation.

Heat transfer plate 26 is a heat transfer body in the form of a plate, and transfers heat generated by phosphor layer 24 to heat dissipation plate 28. Heat transfer plate 26 has a surface in surface-to-surface contact with a surface of substrate 22, and inhibits phosphor layer 24 from reaching high temperatures by absorbing heat generated by phosphor layer 24 via substrate 22, and further transferring that heat to heat dissipation plate 28. Moreover, in sections in direct contact with phosphor layer 24, heat transfer plate 26 absorbs heat from phosphor layer 24 directly rather than through substrate 22. This inhibits phosphor layer 24 from reaching high temperatures. Heat transfer plate 26 is made of a metal having a relatively high rate of heat transfer (for example, aluminum or copper), or another material having a relatively high rate of heat transfer (for example, ceramic or resin). The surface of heat transfer plate 26 that is in contact with heat dissipation plate 28 is referred to as the first surface, and the surface that is in contact with substrate 22 on the reverse side of the first surface is referred to as the second surface. Heat transfer plate 26 is disposed such that its second surface is in surface-to-surface contact with the surface of substrate 22 that is coated with phosphor layer 24, and includes aperture 27 in a location that overlaps a region in which phosphor layer 24 is applied on the second surface.

Aperture 27 is for transmitting, in the positive direction along the Z axis, light passing through or produced by phosphor layer 24. More specifically, aperture 27 is located on an extension of a path of the blue light received by phosphor layer 24, and transmits white light produced from the blue light received by phosphor layer 24 and the yellow light produced by the conversion by phosphor layer 24. Note that aperture 27 corresponds to the first aperture.

Heat dissipation plate 28 is disposed so as to have a surface in surface-to-surface contact with the first surface of heat transfer plate 26, and has aperture 29 in a location that overlaps aperture 27 of heat transfer plate 26. Heat dissipation plate 28 absorbs heat from phosphor layer 24 via heat transfer plate 26 and dissipates the absorbed heat out of lighting device 10. Note that ribs are formed on the surface of heat dissipation plate 28 to increase the surface area and thus more efficiently dissipate heat out of lighting device 10.

Aperture 29 is for transmitting, in the positive direction along the Z axis, light passing through or produced by phosphor layer 24—that is to say, light transmitted through aperture 27—to emit light out of lighting device 10. More specifically, aperture 29 is located on an extension of a path of light, and transmits, out of lighting device 10, white light transmitted through aperture 27 of heat transfer plate 26. Note that aperture 29 corresponds to the second aperture.

Note that the Z axis thickness of phosphor layer 24 is designed to be less than or equal to the Z axis thickness of heat transfer plate 26. Moreover, the Z axis thickness of phosphor layer 24 is designed to be essentially equal to the Z axis thickness of heat transfer plate 26—that is to say, designed such that the interface between phosphor layer 24 and heat dissipation plate 28 and the interface between heat transfer plate 26 and heat dissipation plate 28 are flush with one another. With this, heat dissipation plate 28 absorbs heat generated by phosphor layer 24 directly rather than through substrate 22 and heat transfer plate 26, which increases the amount, of heat transferred.

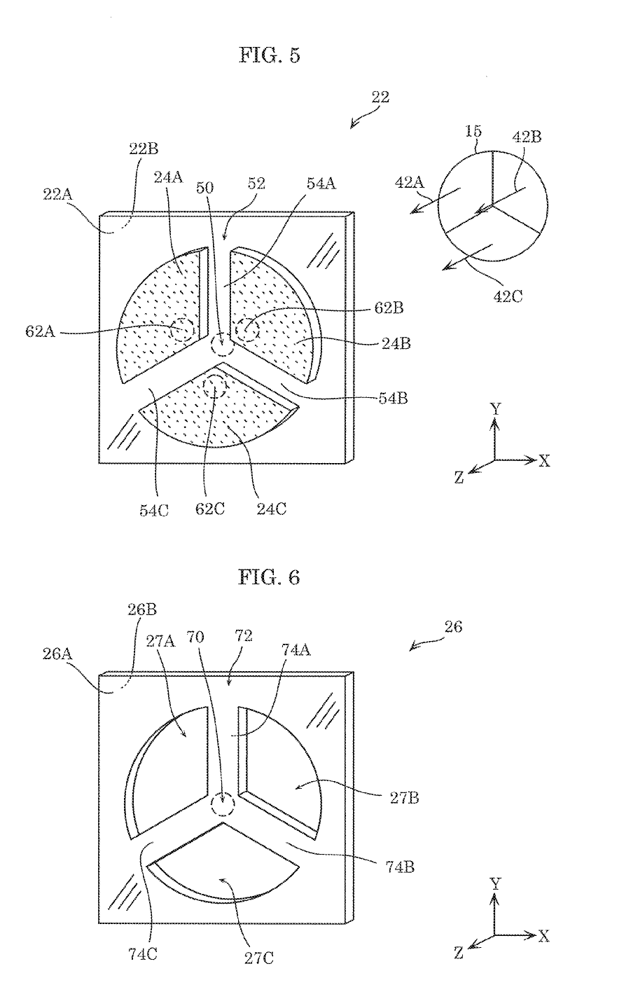

FIG. 5 is a perspective view of substrate 22 according to this embodiment. In FIG. 5, the first surface of substrate 22 is illustrated as surface 22A, and the second surface of substrate 22 is illustrated as surface 22B.

As illustrated in FIG. 5, substrate 22 includes, on surface 22A, regions in which phosphor layers 24A, 24B, and 24C (hereinafter also referred to as “phosphor layers 24A, etc.”), which correspond to phosphor layer 24 described above, are coated. Phosphor layers 24A, etc., receive, from the surface 22B side, beams of light 42A, 42B, and 42C (hereinafter also referred to as “light 42A, etc.”) that have been introduced into lighting device 10 from optical fiber F and fiber coupling 12 and transmitted through lens array 15. The regions in which light 42A, etc. strikes substrate 22 are indicated as regions 62A, 62B, and 62C in FIG. 5. The region in which phosphor layer 24 is coated is, for example, a substantially circular region. Substrate 22 includes regions 54A, 54B, and 54C in which phosphor layer 24 is not coated. Regions 54A, 54B, and 54C are located on lines extending from central region 50 of the circular region toward peripheral region 52.

FIG. 6 is a perspective view of heat transfer plate 26 according to this embodiment. In FIG. 6, the first surface of heat transfer plate 26 is illustrated as surface 26A, and the second surface of heat transfer plate 26 is illustrated, as surface 26B.

As illustrated in FIG. 6, heat transfer plate 26 includes apertures 27A, 27B, and 27C (hereinafter also referred to as “apertures 27A, etc.”). Apertures 27A, etc., are formed in the same shape as phosphor layers 24A, etc., illustrated in FIG. 5. As such, as a result of placing one of substrate 22 and heat transfer plate 26 on top of the other, phosphor layers 24A, etc. and apertures 27A, etc. overlap one another, and light passing through or produced by phosphor layers 24A, etc. in the positive direction along the Z axis is transmitted through apertures 27A, etc.

Moreover, apertures 27A, etc. collectively form a substantially circular shape, and heat transfer plate 26 may include heat transfer bodies 74A, 74B, and 74C (hereinafter also referred to as “heat transfer bodies 74A, etc.”) which divide apertures 27A, etc. With this, heat transfer bodies 74A, etc., can appropriately dissipate heat generated by phosphor layer 24 out of lighting device 10 by transferring the heat to peripheral region 52 of heat transfer plate 26.

Moreover, heat transfer bodies 74A, etc., may extend from central region 70 of to peripheral region 72 of the circular shape formed by apertures 27A, etc. More specifically, heat transfer bodies 74A, etc., may extend from central region 70 to peripheral region 72 of the circular shape formed by apertures 27A, etc in a substantially straight line—that is to say, may be arranged radially. Since light from lens array 15 is incident on substrate 22 in a location relatively close to central region 50, and since thermal paths from central region 50 to peripheral region 52 are relatively long, heat generated by phosphor layer 24 easily pools in the vicinity of central region 50 of substrate 22. In light of this, heat transfer bodies 74A, etc., arranged as described above, can appropriately dissipate heat generated by phosphor layer 24 out of lighting device 10 by transferring heat generated by phosphor layer 24 from central region 50 to peripheral region 52.

Note that heat transfer bodies 74A, etc. may be equiangularly spaced about central region 70. With this, unevenness in the directionality of thermal paths from central region 50 to peripheral region 52 of substrate 22 can be reduced, and the temperature of phosphor layer 24 can be reduced.

Next, results of a simulation evaluating heat transfer properties inside the above-described lighting device 10 will be described.

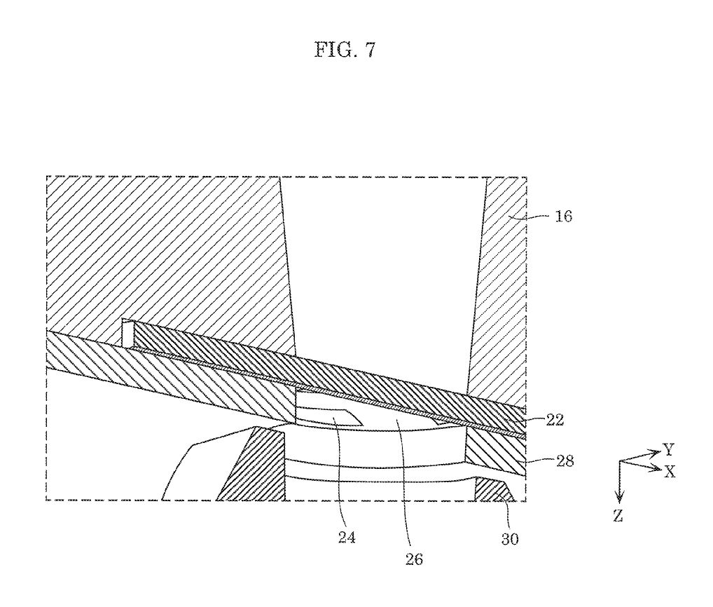

FIG. 7 is a cross sectional view of lighting device 10 according to this embodiment. More specifically, the cross section of lighting device 10 illustrated in FIG. 7 is taken along line VII-VII illustrated in FIG. 1.

The cross section in FIG. 7 illustrates holder 16, substrate 22, phosphor layer 24, heat transfer plate 26, heat dissipation plate 28, and lens 30 of lighting device 10. Hereinafter, in this cross section, a temperature distribution for the above elements when lighting device 10 is emitting light and a temperature distribution for phosphor layer 24 will be shown. Moreover, the same temperature distributions for related technologies 1, 2, and 3, which are three technologies related to lighting device 10, will be shown, and compared with the temperature distributions for lighting device 10. Here, related technology 1 is a lighting device that does not include heat transfer plate 26 or heat dissipation plate 28 included in lighting device 10. Related technology 2 is a lighting device that does not include heat transfer plate 26 included in lighting device 10. Related technology 3 is a lighting device that does not include heat dissipation plate 28 included in lighting device 10.

Note that the simulation is performed by evaluating the temperature of the phosphor layer in a steady state in which the temperatures of each component in lighting device reach an essentially steady value (i.e., a state in which the temperatures of the components are saturated) when each of the above lighting devices are placed in a 30 degrees Celsius environment while they are emitting light.

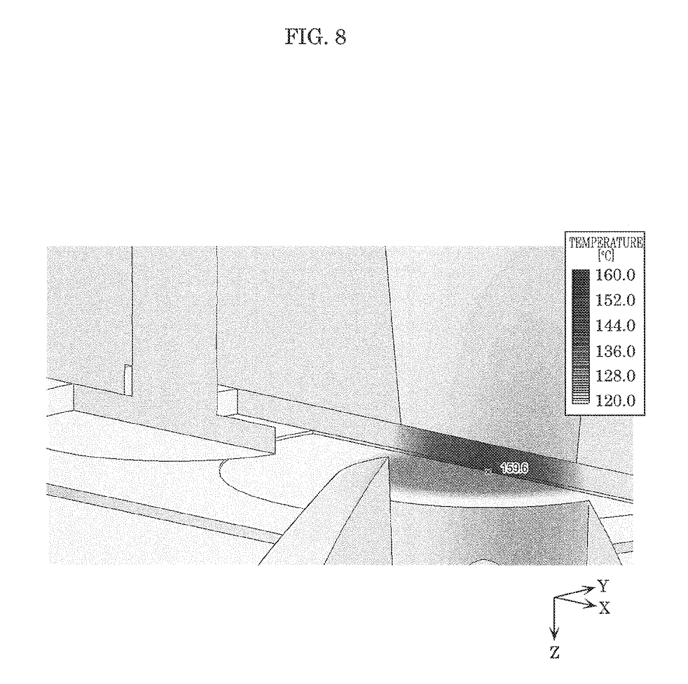

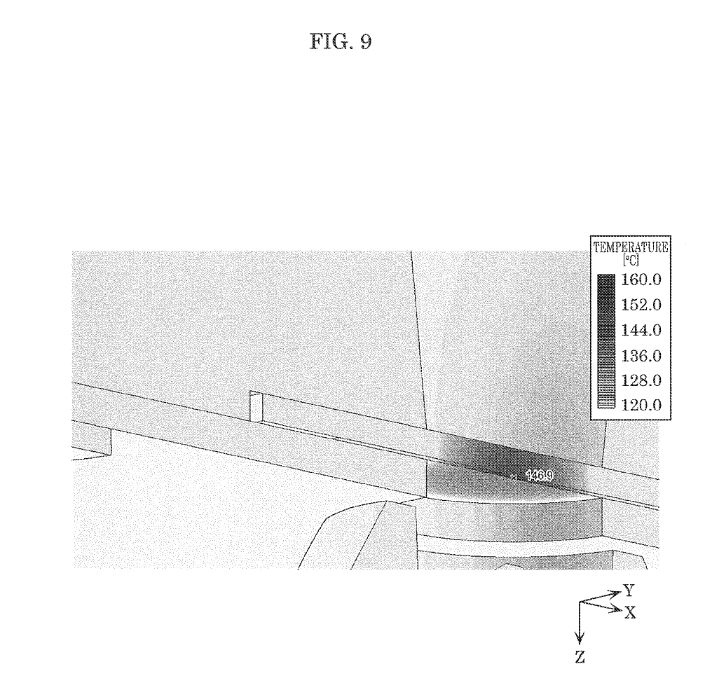

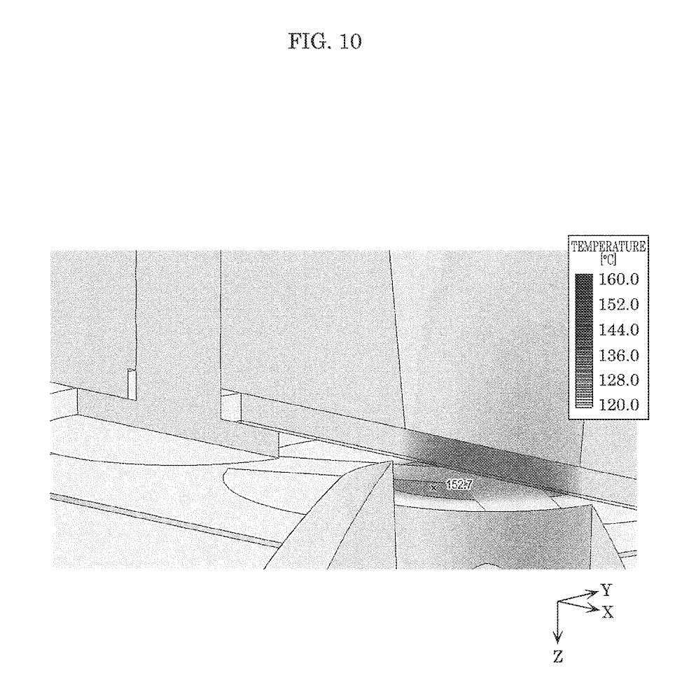

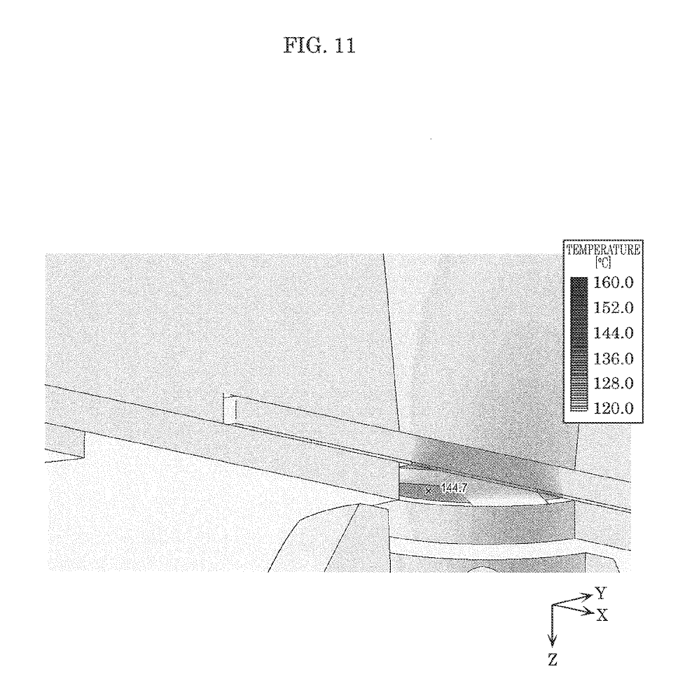

FIG. 8 illustrates a temperature distribution of a cross section of the lighting device according to related technology 1 and a temperature distribution for the phosphor layer. FIG. 9 illustrates a temperature distribution of a cross section of the lighting device according to related technology 2 and a temperature distribution for the phosphor layer. FIG. 10 illustrates a temperature distribution of a cross section of the lighting device according to related technology 3 and a temperature distribution for the phosphor layer. FIG. 11 illustrates a temperature distribution of a cross section of lighting device 10 and a temperature distribution for phosphor layer 24.

The results of the simulations show that the highest temperature values for the phosphor layers in related technologies 1, 2, 3, and lighting device 10 were 159.6 degrees Celsius, 146.9 degrees Celsius, 152.7 degrees Celsius, and 144.7 degrees Celsius, respectively.

As the results show, among the four lighting devices subjected to the simulation, phosphor layer temperature is the highest when neither heat transfer plate 26 nor heat dissipation plate 28 are included, such as in related technology 1, and thus is the least efficient; in terms of heat dissipation. When either heat transfer plate 26 or heat dissipation plate 28 is included, (related technologies 2 and 3), heat dissipation efficiency improves over related technology 1 by a certain amount. Finally, as the results show, since lighting device 10 includes both heat transfer plate 26 and heat dissipation plate 28 and thus heat generated by phosphor layer 24 can be efficiently dissipated out of lighting device 10, the phosphor layer temperature in lighting device 10 was the lowest of all simulation results.

Hereinafter, the specific configuration of lens array 15 will be described.

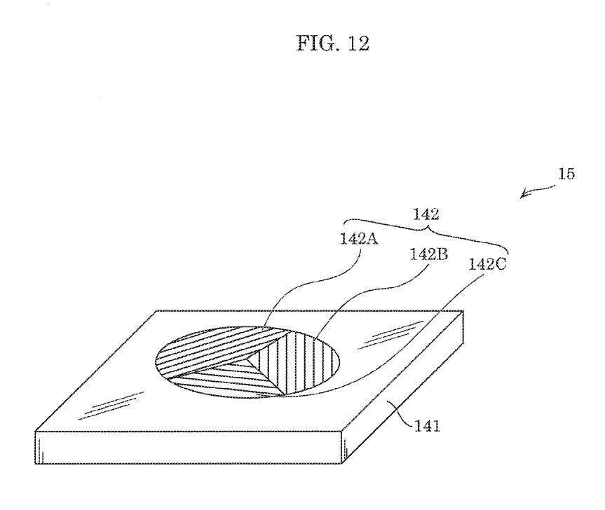

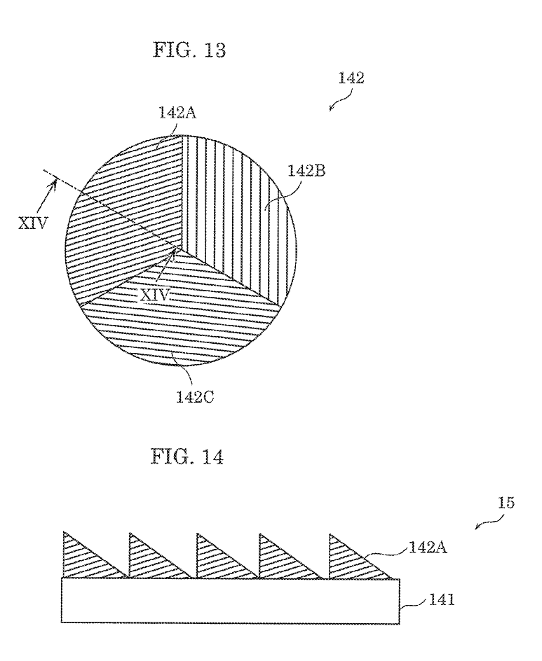

FIG. 12 is a perspective view of lens array 15 of lighting device 10 according to this embodiment. FIG. 13 is a top view of diffractive lens array 142 of lighting device 10 according to this embodiment. FIG. 14 is a cross sectional view taken along line XIV-XIV in FIG. 13.

Lens array 15 is disposed between fiber coupling 12 and phosphor component 20, and splits and separates light guided into lighting device 10 from light source S via optical fiber F and fiber coupling 12, and emits the split and separated light toward phosphor component 20. Lens array 15 is one example of, for example, a microlens array, and includes, for example, substrate 141 and diffractive lens array 142, as illustrated in FIG. 12.

Substrate 141 is a microlens array substrate. Diffractive lens array 142 is formed on substrate 141. Note that substrate 141 may be made of an arbitrary material such as glass or plastic, similar to substrate 22.

Diffractive lens array 142 splits and separates light guided into lighting device 10, and emits the split and separated light toward phosphor component 20. Diffractive lens array 142 has a serrated cross-sectional shape in a plane perpendicular to the surface of incidence of phosphor component 20. Moreover, diffractive lens array 142 includes a plurality of regions. Within each region, the grating is aligned in the same direction. The alignment of the grating is different for each region.

In this embodiment, diffractive lens array 142 is exemplified as including three regions 142A, 142B, and 142C (hereinafter also referred to as “regions 142A, etc.”) exhibiting mutually different grating alignment directions, as illustrated in FIG. 12 and FIG. 13. In FIG. 12 and FIG. 13, the three regions 142A, etc. each include a plurality of linearly aligned lens elements forming a lens array. In each region, the lens elements are arranged in the same direction. Here, when the wavelength of blue light from light source S is, for example, 460 nm, the lens array grating pitch is, for example, 5 micrometers, and the grating height is, for example, 1 micrometer. Moreover, the cross section taken along line XIV-XIV in FIG. 13 has a serrated shape, as illustrated in FIG. 14. Here, the cross section taken along line XIV-XIV corresponds to a plane perpendicular to the surface of incidence of phosphor component 20. FIG. 14 shows the cross-sectional shape of diffractive lens array 142 in region 142A, but regions 142B and 142C also have the same serrated cross-sectional. shapes. In other words, diffractive lens array 142 is what is known as a blazed grating lens array. With this, diffractive lens array 142 can reduce light loss (optical loss) and increase primary diffraction efficiency.

Moreover, in the three regions 142A, etc., of diffractive lens array 142, the direction in which the grating is aligned is different, as illustrated in FIG. 13, for example. With this configuration, even when diffractive lens array 142 splits and separates light guided into lighting device 10, and emits the split and separated light toward phosphor component 20, energy can be inhibited from concentrating on the surface of incidence of phosphor component 20.

Note that the material, used for diffractive lens array 142 is selected depending on the formation method, heat resistibility, and index of refraction of diffractive lens array 142. Methods of forming diffractive lens array 142 include, for example, nano printing, printing, photolithography, electron beam lithography, and particle orientation. Regarding the material used for diffractive lens array 142, when diffractive lens array 142 is formed by, for example, non printing or printing, an epoxy or acrylic resin may be selected as a UV curing resin, or polymethyl methacrylate (PMMA) may be selected as a thermoplastic resin. Moreover, taking into account heat resistance, glass or quartz may be selected as the material used for diffractive lens array 142, and diffractive lens array 142 may be formed by photolithography or electron beam lithography. Moreover, diffractive lens array 142 may be formed using a material having approximately the same refractive index as substrate 141 so that light can more easily enter substrate 141. Furthermore, similar to substrate 141, diffractive lens array 142 is preferably made of a material that is transparent and does not absorb light—that is to say, preferably made of a material having an extinction coefficient of approximately zero.

Next, paths of light inside lighting device 10 when the above-described diffractive lens array 142 is used will be described.

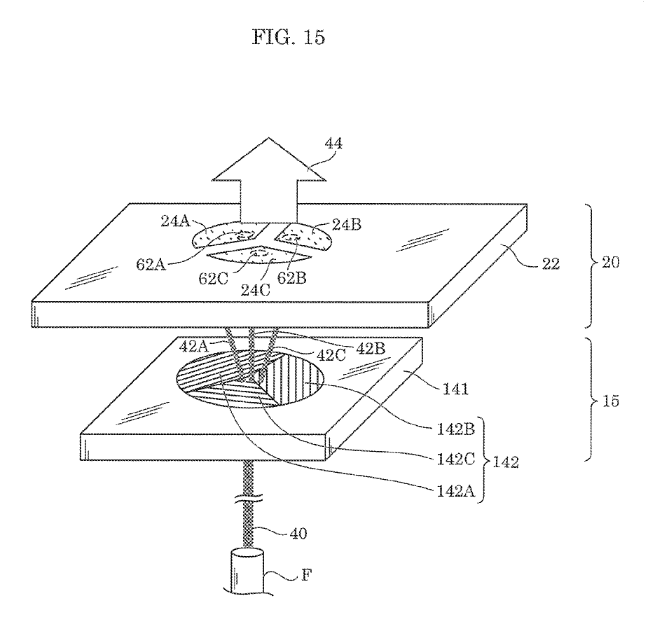

FIG. 15 is a perspective vie illustrating paths of light passing through diffractive lens array 142 of lighting device 10 according to this embodiment.

As illustrated in FIG. 15, in lighting device 10 according to this embodiment, diffractive lens array 142 splits and separates light 40 guided into lighting device 10 into three beams of light 42A, 42B, and 42C (hereinafter also referred, to as “light 42A, etc.”), whereby the three beams of light 42A, 42B, and 42C are emitted toward phosphor component 20. In this way, light 40 guided into lighting device 10 can be split and separated, without greatly changing the spot diameter of light 40 and emitted to phosphor component 20. Moreover, since the split and separated light 42A, etc. is incident in different regions on the surface of incidence of phosphor component 20, energy can be inhibited from concentrating on the surface of incidence of phosphor component 20. Then, phosphor component 20 can produce white light 44 using the incident light 42A, etc.

Hereinafter, two variations of substrate 22 and heat transfer plate 26 will be described..

### (Variation 1 of Embodiment)

In this variation, a lighting device including a heat transfer plate having only one aperture will be described. Note that in the lighting device according to this variation, elements that are common with lighting device 10 according to the above embodiment have the same reference signs and description thereof is omitted.

Similar to lighting device 10, the lighting device according to this variation includes fiber coupling 12, lens 14, lens 30, lens array 15, holder 16, and phosphor component 20. Moreover, phosphor component 20 includes substrate 82, phosphor layer 24, heat transfer plate 86, and heat dissipation plate 28. All of the above elements except substrate 82 and heat transfer plate 86 are the same as the elements sharing the same name in the above embodiment, and as such, detailed description thereof will be omitted.

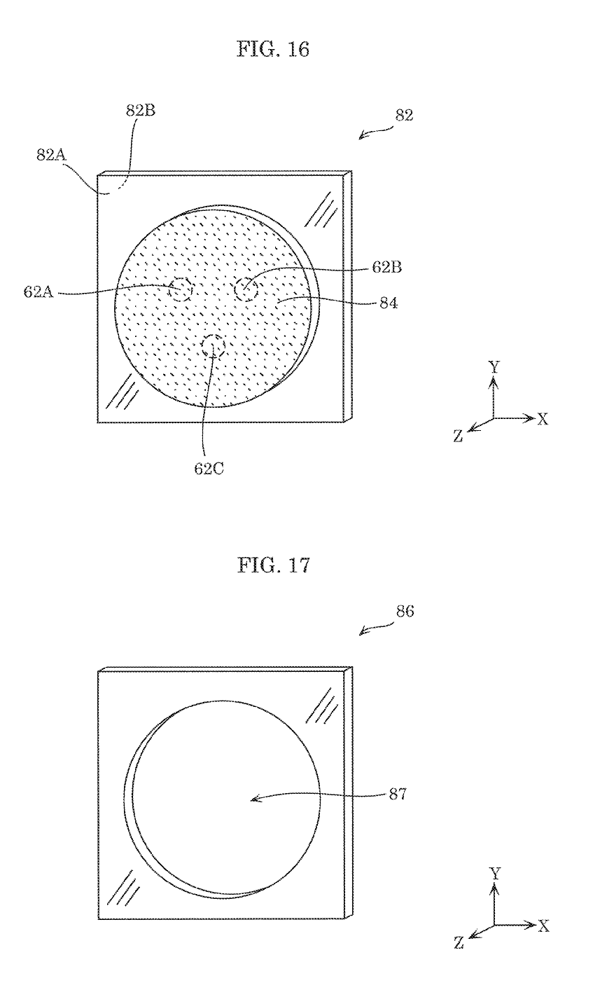

FIG. 16 is a perspective view of substrate 82 according to this variation.

Substrate 82 is a light transmissive substrate having only one region in which phosphor layer 84 is disposed. Phosphor layer 84 receives, from the surface 82B side, beams of light 42A, 42B, and 42C (FIG. 5) that have been introduced into lighting device 10 from optical fiber F and transmitted through lens array 15. FIG. 16 illustrates regions 62A, 62B, and 62C in which these beams of light are incident.

FIG. 17 is a perspective view of heat transfer plate 86 according to this variation.

Heat transfer plate 86 is disposed such that its second surface is in surface-to-surface contact with the surface of substrate 82 that is coated with phosphor layer 84, and includes one aperture 87 in the second surface in a location that overlaps a region in which the single phosphor layer 84 is applied. Aperture 87 is for transmitting, in the positive direction along the Z axis, light passing through or produced by phosphor layer 84.

The lighting device according to this variation can efficiently transfer heat generated by phosphor layer 84 to heat dissipation plate 28 via heat. transfer plate 86. In other words, the lighting device according to this variation can increase heat dissipation efficiency with heat, transfer plate 86.

### (Variation 2 of Embodiment)

In this variation, a lighting device including a heat transfer plate having two apertures will be described. Note that in the lighting device according to this variation, elements that are common with lighting device 10 according to the above embodiment have the same reference signs and description thereof is omitted.

Similar to lighting device 10, the lighting device according to this variation includes fiber coupling 12, lens 14, lens 30, lens array 15, holder 16, and phosphor component 20. Moreover, phosphor component 20 includes substrate 92, phosphor layer 24, heat transfer plate 96, and heat dissipation plate 28. All of the above elements except substrate 92 and heat transfer plate 96 are the same as the elements sharing the same name in the above embodiment, and as such, detailed description thereof will be omitted.

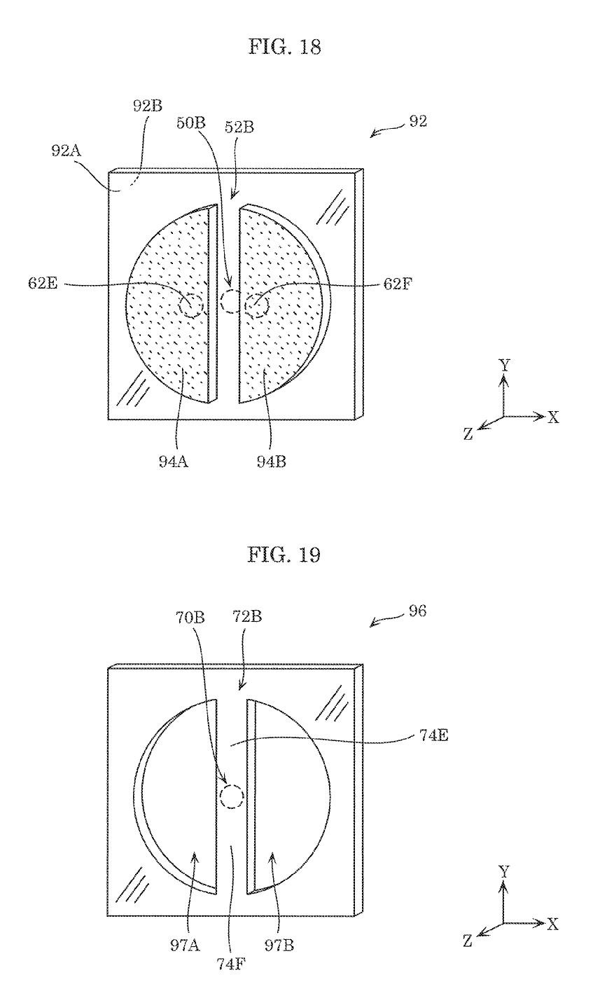

FIG. 18 is a perspective view of substrate 92 according to this variation.

Substrate 92 is a light transmissive substrate having two regions in. which phosphor layer 94A and phosphor layer 94B are disposed, respectively. Phosphor layers 94A and 94B receive, from the surface 92B side, beams of light that have been introduced into lighting device 10 from optical fiber F and transmitted through lens array 15. FIG. 18 illustrates regions 62E and 62F in which these beams of light are incident.

FIG. 19 is a perspective view of heat transfer plate 96 according to this variation.

Heat transfer plate 96 is disposed such that its second surface is in surface-to-surface contact with a surface of substrate 92 coated with phosphor layers 94A and 9413, and includes apertures 97A and 97B in the second surface in a location that overlaps regions in which phosphor layers 94A and 94B are applied. Apertures 97A and 97B are for transmitting, in the positive direction along the Z axis, light passing through or produced by phosphor layers 94A and 94B.

The lighting device according to this variation can efficiently transfer heat generated by phosphor layers 94A and 94B to heat dissipation plate 28 via heat transfer plate 96. In other words, the lighting device according to this variation can increase heat dissipation efficiency with heat transfer plate 96.

As described above, lighting device 10 according to this embodiment includes: substrate 22 that is light transmissive and has one or more regions in which phosphor layer 24 is formed; heat transfer plate 26 having surface 26B in surface-to-surface contact with a surface of substrate 22 and having one or more apertures 27 overlapping the one or more regions; and heat dissipation plate 28 having a surface in surface-to-surface contact with surface 26A of heat transfer plate 26 opposite surface 2B and having aperture 29 overlapping the one or more apertures 27.

With this, heat generated upon phosphor layer 24 converting the wavelength of the light is absorbed by heat transfer plate 26 both directly and via substrate 22, and then transferred to heat dissipation plate 28. In this way, the inclusion of heat transfer plate 26 makes it possible to inhibit phosphor layer 24 from reaching high temperatures. Thus, with lighting device 10, it is possible to avoid an increase in overall size and efficiently dissipate heat.

For example, substrate 22 may have a plurality of the regions, and heat transfer plate 26 may have a plurality of apertures 27, each of which overlaps a different one of the plurality of regions.

With this, heat transfer plate 26 transfers heat generated by phosphor layer 24 to heat dissipation plate 28 even when phosphor layer 24 is disposed in a plurality of locations on substrate 22. Thus, with lighting device 10, it is possible to avoid an increase in overall size and efficiently dissipate heat.

For example, heat transfer plate 26 may have heat transfer bodies 74A, 74B, and 74C that extend from central, region 70 of heat transfer plate 26 to peripheral region 72 of heat transfer plate 26.

With this, heat transfer plate 26 transfers heat generated by phosphor layer 24 from central region 70 of heat transfer plate 26 to peripheral region 72 via heat transfer bodies as well as to heat dissipation plate 28. This makes it possible to inhibit central region 50 of phosphor layer 24, where heat generated by phosphor layer 24 easily pools, from reaching high temperatures.

For example, heat transfer bodies 74A, 74B, and 74C may be equiangularly spaced about central region 70.

With this, it is possible for heat transfer bodies 74A, 74B, and 74C to transfer heat evenly, without directional imbalance, from central region 70 of heat transfer plate 26 to peripheral region 72. This makes it possible to inhibit phosphor layer 24 from reaching high temperatures evenly, without directional imbalance from the perspective of central region 70 of heat transfer plate 26.

For example, an interface between phosphor layer 24 and heat dissipation plate 28 may be flush with an interface between heat transfer plate 26 and heat dissipation plate 28.

With this, heat dissipation plate 28 absorbs heat generated by phosphor layer 24 directly rather than through substrate 22 and heat transfer plate 26, which increases the amount of heat transferred. With this, phosphor layer 24 is can be further inhibited from reaching high temperatures.

For example, phosphor layer 24 may receive incident blue light and convert a portion of the received blue light into yellow light. The one or more apertures 27 of heat transfer plate 26 may be located on an extension of a path of the blue light received by phosphor layer 24, and transmit white light produced from the blue light received by phosphor layer 24 and the yellow light produced by the conversion by phosphor layer 24. Aperture 29 of heat dissipation plate 28 may be located on the extension of the path of the blue light, and transmit, in a direction leading out of lighting device 10, the white light transmitted through the one or more apertures 27 of heat transfer plate 26.

With this, lighting device 10 can use incident blue light to produce and emit out white light, and inhibit phosphor layer 24 from reaching high temperatures.

Lighting apparatus 1 according to the present embodiment includes: the above-described lighting device 10; light source S; and optical fiber F that guides light from light source S to lighting device 10. Phosphor layer 24 on substrate 22 in lighting device 10 receives the light guided by optical fiber F.

With this, lighting apparatus 1 achieves the same advantageous effects as lighting device 10.

### (Other Comments)

Hereinbefore, a lighting device according to the present disclosure has been described based on the above embodiment, but the present disclosure is not limited to the above embodiment.

While the foregoing has described one or more embodiments and/or other examples, it is understood that various modifications may be made therein and that the subject matter disclosed herein may he implemented in various forms and examples, and that they may be applied in numerous applications, only some of which have been described herein. It is intended by the following claims to claim any and all modifications and variations that fall within the true scope of the present teachings.

What is claimed

1. A lighting device, comprising:
a substrate that is light transmissive and has one or more regions in which a phosphor layer is formed;
a heat transfer plate having a first surface in surface-to-surface contact with a surface of the substrate and having one or more first apertures overlapping the one or more regions; and
a heat dissipation plate having a surface in surface-to-surface contact with a second surface of the heat transfer plate opposite the first surface and having a second aperture overlapping the one or more first apertures.

2. The lighting device according to claim 1, wherein
the substrate has a plurality of the regions, and
the heat transfer plate has a plurality of the first apertures, each of which overlaps a different one of the plurality of regions.

3. The lighting device according to claim 2, wherein the heat transfer plate has a heat transfer body that extends from a central region of the heat transfer plate to a peripheral region of the heat transfer plate.

4. The lighting device according to claim 3, wherein the heat transfer body comprises a plurality of heat transfer bodies equiangularly spaced about the central region.

5. The lighting device according to claim 1, wherein an interface between the phosphor layer and the heat dissipation plate is flush with an interface between the heat transfer plate and the heat dissipation plate.

6. The lighting device according to claim 1, wherein
the phosphor layer receives incident blue light and converts a portion of the received blue light into yellow light,
the one or more first apertures of the heat transfer plate are located on an extension of a path of the blue light received by the phosphor layer, and transmit white light produced from the blue light received by the phosphor layer and the yellow light produced by the conversion by the phosphor layer, and
the second aperture of the heat dissipation plate is located on the extension of the path of the blue light, and transmits, in a direction leading out of the lighting device, the white light transmitted through the one or more first apertures of the heat transfer plate.

7. A lighting apparatus,comprising:
the lighting device according to claim 1;
a light source: and
optical fiber that guides light from the light source to the lighting device,
wherein the phosphor layer on the substrate in the lighting device receives the light guided by the optical fiber.
